(19) United States
(12) Patent Application Publication
(10) Pub. No.: US 2026/0043562 A1
(43) Pub. Date: Feb. 12, 2026

(54) SYSTEM AND METHOD FOR REMOVAL OF CO2 FROM INDOOR AIR

(71) Applicant: AIRTHINGS ASA, Oslo (NO)

(72) Inventor: Per Torstein RØINE, Oslo (NO)

(73) Assignee: AIRTHINGS ASA, Oslo (NO)

(21) Appl. No.: 19/120,632

(22) PCT Filed: Oct. 11, 2023
(86) PCT No.: PCT/NO2023/060071

§ 371 Date: Apr. 11, 2025

(30) Foreign Application Priority Data
Oct. 12, 2022 (NO) 20221095

(51) Int. Cl. F24F 8/15; B01D 46/00; B01D 46/42; B01D 46/44; B01D 53/32; B01D 53/34; B01D 53/62; F24F 8/108; F24F 11/61; F24F 11/77; F24F 110/64; F24F 110/70; F24F 120/10

(52) U.S. Cl. CPC F24F 8/15; B01D 46/0047; B01D 46/4272; B01D 46/442; B01D 53/326; B01D 53/346; B01D 53/62; F24F 8/108; F24F 11/61; F24F 11/77; B01D 2257/504; B01D 2258/06; B01D 2273/30; B01D 2279/50; F24F 2110/64; F24F 2110/70; F24F 2120/10

(57) ABSTRACT

A system, and corresponding method, for removal of CO₂ from indoor air, including a fan, at least one electrochemical cell the airflow path, and configured to absorb CO₂ from the air when a voltage V_{A} is applied across the electrochemical cell and to release previously absorbed CO₂ when a voltage V_{B} is applied across the electrochemical cell. A control system adjusts at least one of the speed of the fan and the voltage across the at least one electrochemical cell based on information from at least one of i) a sensor selected from the group consisting of: an air quality sensor and a human occupancy sensor, and ii) a timer configured to determine whether the current time is inside a period of time with high demands on air quality or inside a period of time with low demands on air quality.

### TECHNICAL FIELD

The present invention relates to systems and methods for reduction of particle matter and carbon dioxide concentrations in indoor air. In particular, the invention relates to systems and devices configured to absorb carbon dioxide from indoor air during periods of high concentration and release of absorbed carbon dioxide into the indoor air during periods of lower concentration or into a ventilation system to be transported out of the building.

### BACKGROUND

Human respiration increases the concentration of carbon dioxide, CO₂, in the air. This increased concentration of CO₂ may cause effects on humans ranging from drowsiness and complaints of bad air to headaches, reduced ability to concentrate, and reduced cognitive abilities in general. In industrial settings the increase in concentration of CO₂ may be even higher than in homes and office buildings, with even more serious effects. The excess concentration of CO₂ can be reduced through ventilation, i.e., by exchanging indoor air with fresh outdoor air. However, since the outdoor air may need to be filtered, heated, or cooled, indoor/outdoor air exchange for mitigating elevated CO₂ concentration can contribute significantly to the energy consumption of the building. Practical methods to directly remove CO₂ from the air have typically not been available.

Excessive particulate matter concentration is another common indoor air quality issue, as breathing air with high concentration of particles over time has been associated with significant health risks. In areas with highly polluted outdoor air, the main source of particulate matter even indoors may come from outdoors, but indoor sources such as cooking stoves, fireplaces, candles, and smoking may also be significant. If the source of particulate matter is indoors, increased indoor/outdoor air exchange can be used for mitigation. Otherwise, excessive particulate matter concentration indoors is typically mitigated by an air purifier unit, which uses a fan to circulate the indoor air through a particle (HEPA) filter.

There is a need for alternative methods for reduction of CO₂ in indoor air in order to enable improvement of indoor air quality without the increased energy consumption caused by replacement with outdoor air. Methods that can perform this function in combination with removal of particle matter would be particularly useful.

### SUMMARY OF THE DISCLOSURE

The present invention provides systems and methods that address at least some of these needs.

According to a first aspect the invention provides a system for removal of CO₂ from indoor air. In a first embodiment the system includes a fan arranged to draw air from the surroundings and force the air through the system and back into the surroundings. At least one electrochemical cell is provided in the airflow path of the system, and the at least one electrochemical cell is configured to absorb CO₂ from the air when a voltage V_{A} is applied across the electrochemical cell and to release previously absorbed CO₂ when a voltage V_{B} is applied across the electrochemical cell. A control system is configured to adjust at least one of the speed of the fan and the voltage across the at least one electrochemical cell. The system also includes at least one of a sensor selected from the group consisting of: an air quality sensor and a human occupancy sensor, and a timer configured to determine whether the current time is inside a period of time with high demands on air quality or inside a period of time with low demands on air quality. The control system is configured to receive information from the at least one of a sensor and a timer, determine if the received information is indicative of a need to increase CO₂ absorption from the indoor air, decrease CO₂ absorption from the indoor air, or release absorbed CO₂ from the at least one electrochemical cell back into the indoor air, and based on the determination, perform at least one of: increase the speed of the fan, reduce the speed of the fan, and change the voltage across the at least one electrochemical cell. The control system is further configured to release absorbed CO₂ from the at least one electrochemical cell and back into the indoor air in accordance with at least one of the conditions that the CO₂ concentration is below a predefined threshold as detected by an air quality sensor, that no humans are present in the surroundings as detected by a human occupancy sensor, and that the current time is inside a period of time with low demands on air quality.

Some embodiments of the system further include an air filter provided in the airflow path of the system upstream from the at least one electrochemical cell and configured to remove particles from the air streaming through the air filter. This may serve to remove particles from the air in order to improve air quality and may also protect the at least one electrochemical cell. The air filter may be a particulate air filter in accordance with one of the standards Efficient Particulate Air requirements (EPA), High-Efficiency Particulate Air filter (HEPA), and Ultra Low Particulate Air requirements (ULPA).

In some embodiments where the at least one sensor includes an air quality sensor configured to measure the content of particulate matter in the air, the control system may be further configured to receive a value representative of the measured content of particulate matter in the air from the air quality sensor, and if the received value is above a predefined threshold, to increase the speed of the fan.

In embodiments where the at least one sensor includes a CO₂ sensor configured to measure the concentration of CO₂ in the air, the control system may be configured to receive a value representative of the measured concentration of CO₂ in the air from the air quality sensor, and if the received value is above a predefined threshold, to perform at least one of: increasing the speed of the fan, and changing the voltage across the electrochemical cells to a level which will initiate or increase CO₂ absorption.

In embodiments where the at least one sensor includes a human occupancy sensor configured to detect the presence of humans, the control system may be configured to receive a value indicative of whether humans are present from the human occupancy sensor and to apply the voltage V_{A} across the at least one electrochemical cell if the received value indicates that humans are present, and to apply the voltage V_{B} across the at least one electrochemical cell if the value indicates that humans are not present.

Various embodiments of the invention may also comprise a first airflow direction valve provided in the airflow path between the fan and the at least one electrochemical cell. In these embodiments the control system may be configured to control the first airflow direction valve to adjust the relative proportion of the airflow from the fan that flows through the at least one electrochemical cell. Air that is not flowing through the electrochemical cell may be led past the electrochemical cell and back into the building, or—in some embodiments—out of the building.

Embodiments of the invention may also include a second airflow direction valve instead of or in addition to the first such valve. The second airflow direction valve may be provided in the airflow path downstream from the at least one electrochemical cell and with at least one output configured to lead air back into the surrounding indoor environment and one output configured to direct air to other parts of the building in order to avoid high local concentrations of CO₂ in the indoor environment. The control system may then be configured to adjust the second airflow direction valve to lead air through the output configured to lead air back into the indoor environment when the voltage V_{A} is applied across the electrochemical cell, and to adjust the second airflow direction valve to lead air through the output configured to lead air to other parts of the building when the voltage V_{B} is applied across the electrochemical cell.

In a second aspect of the invention, a method of removing CO₂ from indoor air is provided. The method uses a system with a fan, at least one electrochemical cell configured to absorb CO₂ from the air when a voltage V_{A} is applied across the electrochemical cell and to release previously absorbed CO₂ when a voltage V_{B} is applied across the electrochemical cell, a control system, and at least one of i) a sensor selected from the group consisting of an air quality sensor and a human occupancy sensor, and ii) a timer configured to determine whether the current time is inside a period of time with high demands on air quality or inside a period of time with low demands on air quality. The method includes using the fan to draw air from the surroundings and force the air through the at least one electrochemical cell and back into the surroundings, providing information from the at least one of a sensor and a timer to the control system, using the control system to determine if the received information is indicative of a need to increase CO₂ absorption from the indoor air, reduce CO₂ absorption from the indoor air, or release already absorbed CO₂ from the at least one electrochemical cell back into the indoor air, and based on the determination, perform at least one of increasing the speed of the fan, reducing the speed of the fan, and change the voltage across the at least one electrochemical cell. The determination that the received information is indicative of a need to release already absorbed CO₂ from the at least one electrochemical cell and back into the indoor air in is based on at least one of the conditions that the CO₂ concentration is below a predefined threshold as detected by an air quality sensor, that no humans are present in the surroundings as detected by a human occupancy sensor, and that the current time is inside a period of time with low demands on air quality.

When the system used includes an air filter provided in the airflow path of the system upstream from the at least one electrochemical cell and at least one air quality sensor configured to measure the content of particulate matter in the air, the method may further include using the air quality sensor to measure the content of particulate matter in the air, and if the measured content is above a predefined threshold, using the control system to increase the speed of the fan.

When the system includes at least one CO₂ sensor configured to measure the concentration of CO₂ in the air, the method may further include using the at least one CO₂ sensor to measure the concentration of CO₂ in the air, and if the measured concentration is above a predefined threshold, using the control system to perform at least one of: increasing the speed of the fan, and changing the voltage across the electrochemical cells to a level which will initiate or increase CO₂ absorption.

When the system includes at least one human occupancy sensor configured to detect the presence of humans, the method may further include using the human occupancy sensor to determine whether humans are present, and using the control system to apply the voltage V_{A} causing CO₂ absorption across the at least one electrochemical cell if the received value indicates that humans are present, and to apply a voltage V_{B} across the at least one electrochemical cell if the value indicates that humans are not present.

If the system includes at least one CO₂ sensor configured to measure the concentration of CO₂ in the air of the room or building serviced by the system, and a first airflow direction valve is provided in the airflow path between the fan and the at least one electrochemical cell, the method may include using the at least one CO₂ sensor to measure the concentration of CO₂ in the air, and if the measured concentration is above a predefined threshold, using the first airflow direction valve provided in the airflow path between the fan and the at least one electrochemical cell to adjust the relative proportion of airflow from the fan that flows through the at least one electrochemical cell.

The system may also include a second airflow direction valve, in addition to or instead of the first airflow direction valve. The second airflow direction valve may be provided in the airflow path downstream from the at least one electrochemical cell and with at least one output configured to lead air back into the surrounding indoor environment and one output configured to direct air to other parts of the building in order to avoid high local concentrations of CO₂ in the indoor environment. The method may then include adjusting the second airflow direction valve to lead air through the output configured to lead air back into the indoor environment when the voltage V_{A} is applied across the electrochemical cell, and to adjust the second airflow direction valve to lead air to other parts of the building when the voltage V_{B} is applied across the electrochemical cell.

### BRIEF DESCRIPTION OF THE DRAWINGS

The above and further advantages of the systems and methods provided in accordance with the invention may be better understood by referring to the following description of examples and embodiments in conjunction with the accompanying drawings, in which:

FIG. 1 is a block diagram of embodiments that may be implemented as a standalone units.

FIG. 2 is a block diagram of embodiments that may be implemented as a system integrated in a building.

FIG. 3 is a flow chart representing implementations of decision making that may be made by a control system in embodiments of the invention.

FIG. 4 is an illustration of an embodiment of a system installed in a building.

### DETAILED DESCRIPTION

The present invention provides methods and systems that address the need for alternative methods of improving indoor air without the significant energy expenditure associated with replacement with outdoor air through ventilation, filtering, and heating or cooling.

It should be noted that, unless otherwise stated, different features or elements may be combined with each other whether or not they have been described together as part of the same embodiment below. The fact that several features are described with respect to a particular example should not be construed as implying that those features by necessity have to be included together in all embodiments of the invention. Conversely, features that are described with reference to different embodiments should not be construed as being mutually exclusive. The combination of features or elements in the drawings are intended to facilitate understanding of the invention rather than limit its scope to specific embodiments, and to the extent that alternative elements with substantially the same functionality are shown in respective embodiments, they are intended to be interchangeable across embodiments, not exclusively tied to the embodiment in which they are shown. For the sake of brevity, no attempt has been made to disclose a complete description of all possible permutations of features. As such, the different drawings do not represent distinct embodiments in the sense that they are exclusive alternatives to each other. Instead, the drawings may focus, for example, on different aspects or different levels of detail, or two drawings may show alternatives to more than one feature, and unless there is a dependency between the variations that a skilled person would immediately recognize, the intention is that alternatives may be freely combined from different drawings or parts of the description.

This means that alternative embodiments to those shown in the drawings are arrived at by adding features, by removing features, or by configuring features in a different arrangement than that shown in the exemplary drawings. Unless features are explicitly identified as required or they functionally depend on each other to function they may be omitted, reconfigured, or made to interoperate with additional features not described herein, in any manner that is within the capabilities and knowledge of a skilled person having studied this disclosure. Similarly, if features are described with different levels of detail in sections referencing different drawings, this is not meant to imply that embodiments are constituted either by the lower level of detail or with the higher level of detail. Instead, details described with reference to one drawing are intended to be understood as being available but not mandatory in embodiments, such that none, some, or all features of a detailed example may be imported into a less detailed description unless otherwise stated or unless they clearly depend on each other for their intended operation.

Consequently, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

Electrochemical devices for capture of gases from fluid mixtures, and particularly for capture of carbon dioxide (CO₂) from combustion exhaust or other industrial gas streams, in order to mitigate emission of greenhouse gases contributing to climate change. This technology is, for example, based on electrodes comprising molecules from a class of molecules called quinones. In this type of electrochemical cell CO₂ will easily be attached to the negative electrode, while the positive electrode will release any previously captured CO₂. Attention has primarily been given to designs where fairly large devices are configured for CO₂ capture in industrial settings for later sequestration. It has been suggested that smaller devices may be developed and used in order to capture CO₂ from the air inside buildings in order to remove the CO₂ without having to replace all the air in the building in order to avoid the resulting need to heat or cool the air that is brought into the building in this process. However, this possibility has largely been speculative, and few if any practical designs have been suggested.

The choice of material in the electrodes and other design aspects of the cell itself is not part of the invention as such and will therefore not be described in further detail.

The present invention is based on the realization that capture of CO₂ in buildings for the purpose of improving air quality for occupants is a desirable goal in itself, and the resulting savings in energy that would otherwise be required for heating or cooling is not only an economical saving, but also a contribution towards climate change mitigation even if the captured CO₂ is not sent to sequestration. The present invention therefore focuses on capture of CO₂ during periods of time and in places where the need is highest, and subsequent release either during periods of time or to places where the need is not as high. This is achieved by exploiting the fact that with an appropriately designed cell (or cells) of the type described above, application of a voltage V_{A} across the cell, some of the CO₂ in the air flowing over the electrode surfaces is captured in the cell material, causing reduced CO₂ levels in the air. This process can continue until the electrochemical cells are saturated with CO₂. By applying another voltage V_{B} across the electrochemical cells, captured CO₂ is released to the air flowing over the cell surfaces. After this process, the electrochemical cells that were fully or partly saturated with CO₂ will again be able to capture CO₂ from the air flowing over the cell surfaces by again applying the voltage V_{A}. How high the voltage V_{A} should be depends on the design of the cells and the system as a whole. The principle is that one CO₂ molecule is captured per electron transferred, so the determining factor is the charge density, which is a function of the amount of charge transferred to the electrodes. Increasing the voltage above V_{A} should transfer more charge and cause faster absorption of CO₂, and a lower voltage than V_{A} may in some designs also result in CO₂ capture. In other words, capture efficiency may be a function of voltage. Similarly, V_{B} may typically be of the opposite polarity to V_{A} and charge (in this case removal of electrons from the electrodes) will be transported faster if the magnitude of V_{B} is higher. The voltages V_{A} and V_{B} may therefore also be thought of as voltage ranges (or any given voltage within such ranges) within which the electrochemical cells 104 operate to respectively absorb and release CO₂ as a function of the magnitude of the applied voltage.

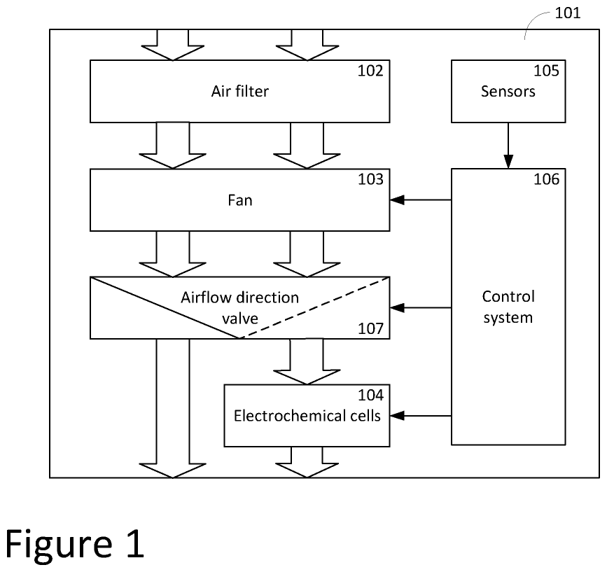

FIG. 1 is an illustration of a number of aspects associated with the present invention. To the extent that some of these aspects are optional they may freely be included or excluded from other embodiments in any combination unless there is a dependency between them that is explicitly mentioned or clearly apparent to those with skill in the art.

The drawing shows a block diagram of a device which may be a standalone unit, much like traditional air purifiers. This unit 101 includes an airflow path in which several components or elements are provided. The airflow path starts upstream with an air intake through an air filter 102. The air filter may be a filter designed to conform to the HEPA standard (High-Efficiency Particulate Air filter), but the invention is not limited to any specific type of air filter, and different requirements could be placed on the particulate filter, which could also be in accordance with Efficient Particulate Air requirements (EPA), or Ultra Low Particulate Air requirements (ULPA). The primary motivation for including an air filter is to remove particulate matter from the indoor air. However, the air filter 102 will, by removing particles from the air before the air reaches other internal parts of the system, in particular the electrochemical cells, from dust and other contaminants.

The air is pulled into the unit 101 by a fan 103. The fan 103 is, in this example, provided after the air filter 102 in the direction of the airflow, but it could also be provided before the air filter 102. However, by placing the air filter first even the fan 103 may benefit from the removal of particles and other contaminants.

In the illustrated embodiment, air, as represented by the 2-dimensional arrows, may flow either directly out of the unit 101 after having passed the fan 103 or it may be pushed into at least one electrochemical cell 104. Embodiments may typically comprise several such cells, and this disclosure will refer to the electrochemical cells 104 in plural, but the principles of the invention are consistent with use of any number of cells. In some embodiments all the air will always pass through the electrochemical cells 104 as there will be only one channel for the air to follow until it leaves the unit 101. In other embodiments the air may be directed outside the electrochemical cells 104. Some embodiments may do this by simply directing some of the air directly out of the unit 101 and while some of the air will pass through the electrochemical cells 104. The ratio between the two may be fixed by the relative cross-sectional area and other flow resistance of the two channels, which in the design process may be based on an assumption that more air needs to flow through the air filter 102 than through the electrochemical cells 104 because the need to remove particles is higher than the need to remove CO₂. This may also depend on the relative efficiency of the air filter 102 and the electrochemical cells 104.

However, the amount of air that is channeled through the electrochemical cells 104 may also be a result of the position of a door, vent, valve, or damper 107 which may be adjusted in order to increase or decrease the relative amount of air flow through the electrochemical cells 104. This component will herein be referred to as an airflow direction valve 107, and this term is intended to include all variants of mechanical direction or interruption of airflow that are suitable for this purpose. In some embodiment the adjustment of the airflow direction valve 107 may be manual, such that a user may manipulate the airflow by turning a knob, pushing a lever, or operating a switch. In other embodiments the adjustment may be the result of sensor input to a control system 106. Some embodiments do not include the airflow direction valve 107.

In the embodiment illustrated in FIG. 1, sensors 105 are included as part of the unit. These sensors may, in some embodiments, be supplemented or replaced by external sensors that are connected to the unit with a communication link. The invention may include one or more sensors selected from air quality sensors, human occupancy sensors, and sensors related to the operation of the unit itself. Air quality sensors may include particulate matter sensors and CO₂ sensors. Human occupancy sensors, of which many are known in the art, may be configured to detect whether humans are present in a room or area. Sensors related to the operation of the unit itself may particularly include one or more temperature sensors for tracking the temperature of the electrochemical cells 104. The sensors 105 will provide data to the control system 106 in the form of values that are representative of a measurement or detection performed by the sensors.

The output from the sensors 105 is provided to the control system 106. The control system may be configured to determine the need for removal of particulate matter from the air based on current content and human occupancy, and make a similar determination based on CO₂ content in the air and human occupancy. If the need for either is increasing, this increasing need may be met by increasing the speed of the fan 103, which will affect both filtering and CO₂ removal in the same direction, adjustment of the relative airflow through the electrochemical cells vs. directly out of the unit 101 without passing through the electrochemical cells 104, and the voltage over the electrochemical cell 104. The latter two enable control of the two relative to one another. If the sensors 105 also include sensors relating to the internal operation of the unit 101, the control system 106 may also adjust operation based on this, for example by reducing the voltage over the electrochemical cells 104 if the temperature in the cells is too high.

The combination of features described above enables limitation of indoor particulate matter levels as well as indoor CO₂ levels. By filtering at the air intake and adjusting the utilization of the electrochemical cells 104 based on need, the CO₂ capture capacity and lifetime of the electrochemical cells 104, as well as system energy consumption, and ambient noise may be significantly improved.

The unit 101 described above is capable of absorbing particulate matter in the air filter 102 and CO₂ in the electrochemical cells 104. However, the unit 101 as illustrated in FIG. 1 does not provide any method for removing either automatically. In order to remove particulate matter from the air filter 102 it is necessary to either remove and clean the filter or to replace it with a new filter and dispose of the old filter. Similarly, when the electrochemical cells 104 are saturated, they must release the CO₂ already absorbed before they again can start to absorb CO₂. Electrochemical cells 104 of the type described above will release CO₂ when the voltage over the cells is reduced or reversed. A unit 101 according to the invention may therefore be configured to be removed or at least to allow the cells 104 to be removed, such that the CO₂ can be released somewhere else, for example outdoors or somewhere it may be captured for sequestration. However, another alternative is to release the CO₂ during periods of time when the building, or room, is not occupied by people. This may be determined by a schedule or by an occupancy detector which may be one of the sensors 105. If the CO₂ is released back into the indoor air for example at night it will slowly be removed from the building as part of the continuous exchange of air between the indoor and the outdoor environment, but not as part of an additional exchange of air because of CO₂ buildup. Thus, no additional use of energy for heating or cooling will be required. Release of CO₂ will be described in further detail below.

With respect to terminology, the present disclosure will use the terms absorb and absorption. This should be interpreted in a wider sense than the strict chemical definition of a process in which atoms, molecules, or ions enter a liquid or solid material, which is distinct from adsorb and adsorption, which is adhesion of atoms, molecules, or ions to a surface. Instead, the terms absorb, and absorption are chosen because they are readily understood, and they should be interpreted as including processes that according to a strict definition is adsorption. Absorb and absorption may therefore be read as synonymous with capture.

In a unit 101 like this, one or more thresholds may be defined for respectively particulate matter content and CO₂ content in the indoor air. If the content of particulate matter increases above a defined threshold, the speed of the fan 103 may be increased. If a threshold for CO₂ content increases above a defined threshold the speed of the fan 103 may be increased, the voltage across the electrochemical cells 104 may be increased, or the relative proportion of air that is directed through the electrochemical cells 104 may be increased as described above. If only one of these, either the content of particulate matter or the content of CO₂ is above the threshold, which parameter to change may depend on the specific situation. An example is given in the table below.

| Particulate matter | | |
|---|---|---|
| concentration | CO₂ concentration | Possible control system response |
| Stable below threshold | Stable below threshold | System off, or at minimum operation |
| Stable below threshold | Fell below threshold | Reduce fan speed, or |
| | | Reduce voltage across cells, or |
| | | Direct air past cells |
| Fell below threshold | Stable below threshold | Reduce fan speed |
| Fell below threshold | Fell below threshold | Reduce fan speed, or |
| | | Reduce voltage across cells, or |
| | | Direct air past cells |
| Rose above threshold | Below threshold | Increase fan speed |
| | | Retain or reduce voltage across cells |
| | | Direct more air past cells |
| Below threshold | Rose above threshold | Increase or maintain fan speed, or |
| | | Increase voltage across cells, or |
| | | Direct more air through cells |
| Already above threshold | Rose above threshold | Increase fan speed, or |
| | | Increase voltage across cells, or |
| | | Direct more air through cells |
| Rose above threshold | Already above threshold | Increase fan speed |
| | | (Reduce voltage across cells) |
| | | (Direct less air through cells) |
| Above threshold | Above threshold | Stable operation, or increase |
| | | one or more variables |

The table illustrates an example with only one threshold for each concentration. Embodiments of the invention may include more than one threshold in order to increase control variables stepwise and taking into consideration which of the two concentrations it is currently most important to reduce. Some embodiments may not operate with discrete thresholds but instead let the control output be a function of the values of the two control variables (and possibly additional control variables like time of day, presence of humans, etc.). It will be understood that how the sensor input is used to control the system is independent of many other design choices that have been or will be described herein, and these examples should be considered available to any embodiment as long as the embodiment includes the required sensor or other required control information (e.g., a defined schedule), and as long as a given control is available to be adjusted (e.g., fan speed, voltage, valve for directing air, etc.).

The example in the table starts with a situation where both concentrations are stable below their defined thresholds. In that case there is no need for any adjustment and the system may be off or running at a minimum level of operation.

The next line in the table relates to a situation where the concentration of particulate matter is stable below the defined threshold and the concentration of CO₂ has just fallen below the threshold. In this situation, the operation of the system may be reduced in order to reduce energy consumption and/or noise, as well as increase the lifetime of the electrochemical cells 104. This means that the speed of the fan 103 may be reduced, the voltage across the cells 104 may be reduced and air that was directed through the electrochemical cells 104 may now be directed past them. In some embodiments the system may simply be turned off at this point. However, this may result in an immediate increase back up above the threshold(s) and the controls may, for example, be gradually reduced in order to establish a stable condition below the thresholds at a minimum level of operation.

In the following line the reverse is the situation, namely that the particulate matter concentration has just fallen below the threshold while the CO₂ concentration has already been stable below threshold for some time. In this situation the voltage across the electrochemical cells 104 and the amount of air directed through the cells is presumably already low or zero, but the fan speed may be reduced. The next line is included for completeness. If both parameters have just fallen below their respective thresholds, all control variables may be reduced, but perhaps gradually in order to obtain a stable situation and avoid immediate return to a situation where one or both parameters are above threshold.

The next line in the table describes one where the particulate matter concentration has just risen above the threshold while the CO₂ concentration is stable below the threshold. In this situation there is no need to increase the load on the electrochemical cells 104, but the fan speed should be increased in order to increase removal of particulate matter. Since fan speed is increased, the voltage or the relative air flow through the electrochemical cells 104 may possibly be reduced in order to maintain the same level of CO₂ absorption even though the total air flow has increased, thus reducing energy consumption, and increasing lifetime of the cells.

If the situation is the reverse, as in the following line, namely that the particulate matter concentration is stable below threshold, but the concentration of CO₂ has just risen above threshold, there are several possibilities. Increasing the fan speed may increase CO₂ removal, but it will also increase removal of particulate matter, which is not necessary. Increasing the voltage over the electrochemical cells 104 or increasing the portion of air flowing through the cells will increase CO₂ removal without increasing removal of particulate matter. Avoiding increased fan speed may also keep the noise produced by the 101 at a lower level. However, which control variable(s) to adjust may also depend on how high each variable is already adjusted (for example if the fan speed is already at maximum, it cannot be further increased). The different control variables may have different energy costs, and this may be taken into consideration when determining how the control variables should be adjusted.

The next line represents a situation where particulate matter concentration is already above threshold and CO₂ concentration has just risen above threshold. In this situation, the fan speed is presumably already high, but, if possible, it may be increased, something that should increase removal of both particulate matter and CO₂. Increasing cell voltage or relative air flow through the cells will increase CO₂ removal but will not increase removal of particulate matter.

In the following line, it is the particulate matter concentration that has just risen above threshold while CO₂ concentration is already above threshold. The only relevant response to the increased concentration of particulate matter is to increase fan speed. Assuming that the current voltage across the cells and air flow through the cells is the result of an adequate response to the CO₂ concentration it is possible that the voltage across the cells and/or the relative airflow through the cells may be reduced since the increased fan speed should result in increased CO₂ removal which may not be necessary.

The final line in the table represents a situation where both parameters are above threshold. If this situation has already been responded to, or if all control variables are already at their maximum (or there are other reasons not to increase any of them, for example noise, cell temperature, or energy consumption) the unit 101 may continue in stable operation. Otherwise, it may be necessary to increase one or more control variables in order to increase removal. Again, fan speed is the only control variable that will increase removal of particulate matter, while all variables may contribute to CO₂ removal.

Another factor that may influence which control variables to adjust, and how much, is the saturation grade of the electrochemical cells 104. The extent to which this may be taken into consideration, and how, may depend on the characteristics of the materials and design chosen for the cells and must be determined by the designer of the unit 101. Based on known characteristics of the electrochemical cells 104, a “digital twin” of the electrochemical cells can be used to model the saturation grade of the cells. For each time unit, the state of the model is updated based on the measured CO₂ level in the air, the airflow over the cell surfaces calculated from the fan speed, and the voltage and current applied to the electrochemical cells, and optionally the measured working temperature of the cells. The model may be calibrated by measurements taken during development of the system and/or during the production of each unit, and also refined by real-time CO₂ level measurement. For example, the model coefficients may be updated/refined if there are discrepancies between a prediction of the change in CO₂ level based on the modeled saturation level and current parameters, and the actual measured change in CO₂ level. The impedance (ratio between applied voltage and current) and the working temperature of the electrochemical cells 104 may also be measured, and the model coefficients may be refined or updated if there are discrepancies between the impedance or working temperature predicted by the model and the results of the measurements.

The table shown and described above only discusses responses to the crossing of a threshold that indicates an undesirable high level of at least one of particulate matter concentration and CO₂ concentration. (There may be more than one threshold for each parameter, where a higher threshold indicates an even more undesirable situation requiring increased removal, and possibly less consideration for other parameters such as noise or energy consumption.) However, there may also be a low threshold, particularly for CO₂ concentration. The low threshold may represent a situation where it is acceptable to release CO₂.

As described above, when the electrochemical cells 104 become saturated with CO₂, the system needs to release the CO₂ again before having further ability to limit ambient CO₂ level. This process may be controlled by sensing the CO₂ level in the air, or occupancy, or both, and it may also be scheduled to occur for example outside office hours or during night. Typically, when ambient CO₂ level is below the low threshold, and the saturation level of the electrochemical cells is above a certain level as determined by the “digital twin” model, the voltage over the electrochemical cells may be adjusted to the range (around V_{B}) where the electrochemical cells start releasing CO₂, and at the same time the fan speed controlled to ensure adequate airflow over the cell surfaces for efficient CO₂ release. Furthermore, an optional sensor measuring the working temperature of the electrochemical cells may be used to adjust the voltage across the cells and/or the fan speed to keep the working temperature during CO₂ release within a desired range. In addition, the CO₂ release may occur at different combinations of voltage across the electrochemical cells and fan speeds, to optimize either energy consumption of the system, or ambient noise from the fan when there are people present, or both. Different combinations of voltage across the electrochemical cells and fan speeds may also be applied as a function of the saturation grade of the electrochemical cells.

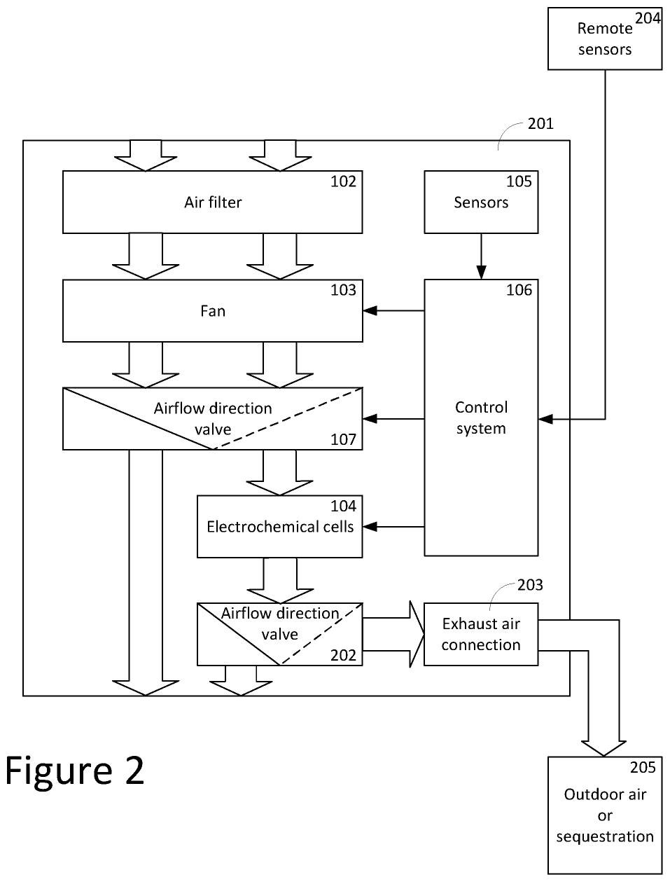

The principles illustrated in FIG. 1 relate to embodiments of standalone units. However, most of these principles also apply to other embodiments. FIG. 2 is an illustration of principles relating to embodiments that are integrated in a building's ventilation and air circulation system, which otherwise typically consists of one or more fans, one or more air filters (typically HEPA, but may also be EPA, ULPA or any other suitable type of filter), controllable ventilation valves and dampers, as well as tubes, pipes, ducts, or shafts distributing air. The principles relating to sensors and control of the fan and the electrochemical cells described with reference to FIG. 1 also apply to embodiments that will be described with reference to FIG. 2 below. In addition, these embodiments also enable controlling of the mix of indoor and outdoor air. For example, if the outdoor air has a high level of particulates (PM1/PM2.5/PM10) or has significantly different temperature than the desired indoor temperature, which would require significant energy for heating or cooling outside air moved into the building, the system can prioritize indoor air circulation, and use the electrochemical cells to capture excessive CO₂ in the circulated air when high CO₂ levels are measured. In this way, air with a high concentration of particulate matter or air which requires a significant amount of energy to heat or cool, will not be introduced into the building.

On the other hand, if the outdoor air has a low level of particulates, or has a temperature near the desired indoor temperature, thus requiring little energy for heating or cooling, the system can prioritize indoor/outdoor air exchange, and avoid using the electrochemical cells to capture excessive CO₂, thereby optimizing system energy consumption and electrochemical cell lifetime.

Reference is now made to FIG. 2, wherein the components that are substantially performing the same function are given the same reference number as the corresponding component in FIG. 1. This drawing is, however, not intended to illustrate a standalone unit, but a system that is integrated into the ventilation and air circulation system of a building. Such a system otherwise typically consists of one or more fans, one or more particle filters, controllable ventilation valves and/or dampers, as well as tubes, pipes, ducts, or shafts for introducing, distributing, and exhausting air. The drawing shows a system 201 comprising an air filter 102, a fan 103, electrochemical cells 104, sensors 105, and a control system 106. A first airflow direction valve 107 may be included, as described above, in order to regulate the amount of air that is directed through the electrochemical cells 104. In this embodiment the various components already described are typically not part of a single unit but distributed inside a building. For example, air intake may be positioned in several rooms and connected to ducts that transport air to an air filter 102. The air filter 102 may be one of several such filters and it may be positioned in the vicinity of a fan 103 or at least connected to a duct that transports air from the filter 102 to a fan 103. The fan 103, which again may be one of several such fans, will pull air through the air filter 102 and the same air will then be pushed towards one or more electromechanical cells 104. As with the standalone unit 101, the system 201 may include an airflow direction valve 107 which may direct more or less of the air coming from the fan 103 through the electrochemical cells 104.

It will therefore be understood that embodiments of the system 201 illustrated in FIG. 2 has the same capabilities as the standalone unit 101 already described but adds additional possibilities. Through integration with the ventilation and air circulation system (hereinafter referred to as HVAC, which stands for Heating, Ventilation and Air Conditioning) of a building, the system 201 can operate not only contingent on particulate matter concentration and CO₂ concentration as measured by the local sensors 105, and saturation of the electrochemical cells 104 as estimated by the “digital twin”. In addition, the HVAC system, and any additional remote sensors 204, may provide information about concentration of particulate matter in the outside air (or difference in concentration outside and inside the building), temperature difference between the outside and inside air, saturation of electrochemical cells 104, and possibly even additional parameters that may be relevant to whether or not it is desirable to introduce outside air into the building, such as, for example, pollution or humidity.

The operation of a system 201 according to the invention when it is integrated with a building's HVAC system may therefore be configured to receive input from the HVAC system or other sensors indicating that conditions inside and outside the building are sufficiently similar that replacement of inside air with outside air is acceptable. If this is the case, the system 201 may not need to remove CO₂ because there are no appreciable energy costs (or other disadvantages such as introduction of pollution or humidity) associated with air exchange. Whether it is the HVAC system that determines this and instructs the CO₂ removal system 201 or vice versa is an academic question with no practical consequence since the two are integrated parts of one system, and the air filter 102, fan 103, sensors 105, and control system 106 may be part of the HVAC system as such. Alternatively, some or all of this functionality may be supplemental to or complementary to functions already provided by the HVAC system if the CO₂ removal system 201 is installed as a modification to an already existing HVAC system.

If it is determined that particulate concentration in the outside air, temperature difference, or both, are too high, the control system 106 may determine that the electrochemical cells 104 should be activated and air should be directed through the cells. Consequently, the fan 103 and the airflow direction valve 107 as well as the voltage across the electrochemical cells 104 may be controlled accordingly. Control variables may be determined in the same manner as for the standalone unit 101 described above.

However, when the electrochemical cells 104 are integrated in a building's HVAC system, it may be possible to switch the positions of valves and/or dampers such that the air flowing through the electrochemical cells 104 passes through a second airflow direction valve 202 which directs the air either back into the building or out through an exhaust air connection 203. In this way, the system 201 may be configured to direct air back into the building when the electrochemical cells operate to absorb CO₂ and to direct air out through the exhaust air connection 203 when the voltage across the cells are changed to V_{B} and the cells start to release CO₂. The exhaust air connection 203 may simply direct CO₂ rich air out of the building, or it may be transported to a system designed for CO₂ capture and sequestration. In this way CO₂ may be released to the outside of the building when cells are saturated, and the electrochemical cells 104 may subsequently be returned to operation and the second airflow direction valve 202 may again direct air from the cells back into the building. The result of this process is that only a little air with a very high concentration of CO₂ is transported out of the building which means that only a little outside air has to be transported into the building to replace it. This means significant reduction in energy needed to heat or cool the introduced outside air.

It will be realized that while the illustration in FIG. 2 only shows one of each component, a system in a large building could include a plurality of components of each type, and they could be located adjacent to each other or with a certain distance from each other and connected by ducts. One particular significance of this is that with several units of electrochemical cells 104 that operate independent of each other, some cells may be operating to absorb CO₂ in order to recycle indoor air, while other cells operate to release CO₂ out of the building. In this way the system may always have some cells that are actively removing CO₂ from the indoor air even if other cells are saturated.

It should be realized that the embodiment of a system 201 illustrated in FIG. 2 includes features that may be missing from some embodiments. For example, the second airflow direction valve 202 and the exhaust air connection 203 could be excluded, in which case the system would operate much like the standalone unit 101 to release CO₂ not into the outside air or to a sequestration system, but to parts of the building or during periods of time where occupancy is low or absent. For that purpose, the second airflow direction valve 202 may also be included but only configured to direct air to other parts of the building in order to avoid high local concentrations of CO₂ for example in meeting rooms, conference rooms, rooms where CO₂ is also released by machinery, and so on.

The first airflow direction valve 107 is, as in the standalone units 101 a feature that may or may not be present, and that may have a number of different configurations, as described with reference to FIG. 1.

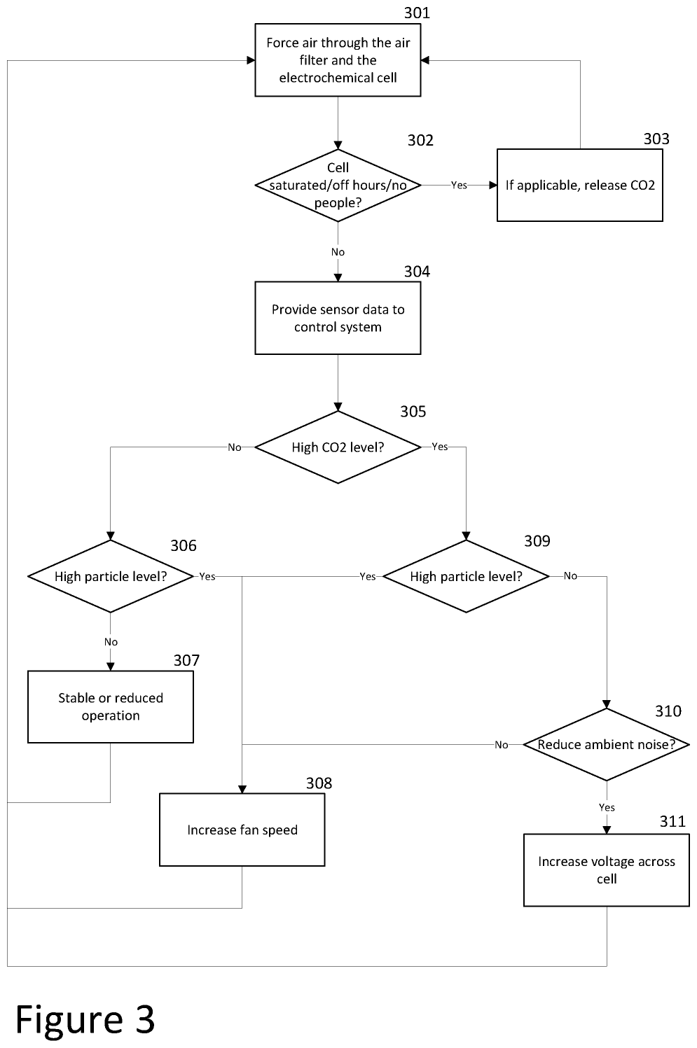

Reference is now made to FIG. 3, which illustrates the principles of a method consistent with the principles of the invention. It should be understood that various embodiments of the invention may implement many different conditions upon which the CO₂ and particle removal system is controlled and that it is impossible to illustrate them all in a single flowchart. It should also be understood that a flowchart explains how decisions are made by presenting them sequentially as if each determination of the value of a parameter and the decision made based on that value were performed in discrete steps, one after another and then repeated. This does not have to be the case in a real implementation of a system where instead a number of parameters are monitored continuously and when one or more of the parameters change it is determined whether and how to change control variables in response to the changed environment. The flowchart in the drawing and the attendant description should therefore primarily be understood as an explanation of how different parameters may influence each other, and not as a strict description of how information flow, decision making, and system control actually is performed. In particular it should be understood that some of the actions described as steps in the flowchart may be performed continuously (e.g., the forcing of air through the air filter and the electrochemical cell) while some steps are more discrete (such as increase of the fan speed). For simplicity the flowchart shows decisions relating to fan speed and cell voltage control as being either/or decisions, while in many embodiments the reality will be that the two are both being adjusted at the same time, sometimes in the same direction, at other times in opposite directions.

Finally, the flowchart does not include control of airflow by way of the first 107 and second 202 airflow direction valve. This does not mean that embodiments consistent with the drawing do not include airflow control. It is simply a result of a need to simplify the drawing in order to explain certain aspects of the invention. Thus, any embodiment consistent with the drawing in FIG. 3 may be supplemented by one or both airflow direction valves as well as additional airflow control devices, other sensor input, and so on.

That being said, the flowchart starts with a step 301 of forcing air through the air filter 102 and electrochemical cells 104. This step runs continuously unless the entire system is shut down, either by stopping the fan, or by directing all air outside the electrochemical cells 104. In a next step 302 it is determined whether at least one of the following conditions are fulfilled, namely that the electrochemical cell 104 is saturated with CO₂, that the system is now operating in “off-hours” which constitute a period of time with relatively low demands on air quality, or that a sensor detects that no people are present in the area where the system is configured to control air quality. Various embodiments of the invention may implement one or several of these conditions. If at least one of them is fulfilled the system may move to step 303 where the voltage across the electrochemical cells 104 is changed such that absorbed CO₂ is released. This may continue until the condition in step 302 is no longer fulfilled, or in accordance with some additional rule. Release of CO₂ due to saturation may in some embodiments be suspended until additional conditions are fulfilled, for example that off hours start, or people have left the area. If so, the system may have to retain CO₂ without being able to absorb more CO₂ for the time being.

If the conditions in step 302 are not fulfilled, the system will continue normal operation and move to step 304 where sensor and/or timer information is obtained by the control system 106 and evaluated. The sensor data may include information on CO₂ concentration as well as concentration of particulate matter in the surrounding air. Sensor data may include additional information relating to occupancy, outside/inside temperature difference, and more, but these additional possibilities are not included in the description of this drawing for the purposes of simplifying the illustration and explanation to a few central principles.

It can now be determined in step 305 whether the CO₂ level is too high. If this is not the case, it may be determined in step 306 whether the concentration of particulate matter is too high. If this also is not the case, operation may continue unchanged 307, or it may even be reduced in order to save energy and increase system lifetime. The system may then return to step 301. If it is determined in step 306 that particle concentration level is too high, the process may move to step 308 where the control system increases the fan speed. As explained above, the only way to reduce concentration of particulate matter is to increase fan speed. The system may then return to step 301.

If it was determined in step 305 that CO₂ level is too high, the method will instead move to step 309, which performs the same evaluation as step 306 namely determine if particle concentration level is too high. If it is, the process may again move to step 308 where fan speed is increased. As explained above, this should result in a reduction in both particle concentration and CO₂ concentration. Of course, this may be combined with an increase in voltage over the cells, or with a change in airflow in embodiments which implements this. Following step 308 the process will return to step 301.

If it is determined in step 309 that the particle level is not too high, the process may instead move to step 310 where it is determined whether it is necessary to reduce ambient noise. This may be determined based, for example, on input from a human occupancy sensor, or a rule associated with time of day. If it is not necessary to reduce ambient noise the process may again move to step 308 and increase fan speed (possibly combined with increase in cell voltage), and proceed as described for step 308 above.

If it is determined in step 310 that ambient noise should be reduced the process may instead move to step 311 and increase voltage across the cells 104 (possibly in combination with reduced fan speed and changed air flow). The process may then return to step 301.

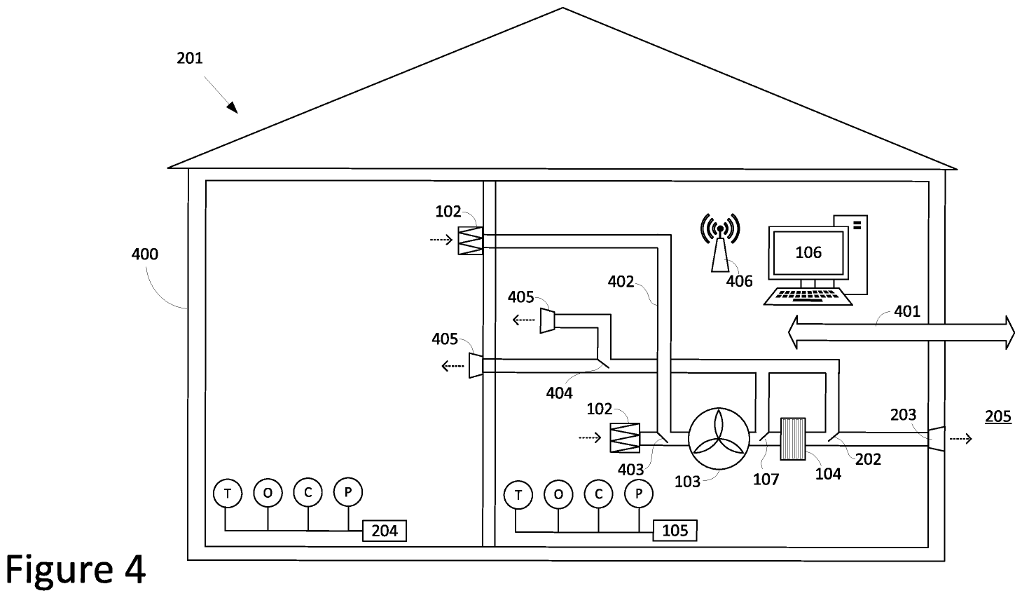

Reference is now made to FIG. 4 which illustrates a system 201 according to the invention installed in a building 400. Since the building is not airtight, a certain amount of infiltration and exfiltration 401 will take place independent of the active ventilation system of which the system 201 is part. The system 201 includes several ventilation ducts 402 connecting the various components of the system 201 and constituting the airflow path through the system 201. The building 400 includes two rooms and the system does not have to treat the two rooms the same, as will become clear from the following description.

When the fan 103 pulls air from the rooms, air will pass in through filters 102 and into the ducts 402. In this example the air filters 102 are at the very beginning of the airflow path, with one filter in each room. Other embodiments, that otherwise may share all details with the illustrated embodiment, may have one common filter 102 arranged just before the fan 103, or even after the fan 103. A damper or valve 403 may be adjusted to determine the amount of air the fan 103 should pull from the respective rooms. If this damper 403 is in one of the extreme positions the fan 103 will only pull air from one of the rooms. If it is in any intermediate position, air will be pulled from both rooms, possibly in proportion to how much the damper 403 is adjusted towards one of the extreme positions.

Following the fan 103 there is an airflow direction valve 107. This valve 107 will in one extreme position lead all air into the electrochemical cells 104 for CO₂ absorption. In the other extreme position, the airflow direction valve will lead all airflow past the electrochemical cells 104. Air that is directed outside the electrochemical cells 104 will be directed back into the building 400. This air has been subject to particle filtering in the air filter 103 but not to any CO₂ removal. In principle the system 201 could include the possibility to lead this air out of the building, but there is no need to filter particles from air that is being transported out of the building so this option is not illustrated in the drawing.

The air that has passed through the electrochemical cells 104 has been subject to CO₂ absorption by the electrochemical cells 104, or CO₂ has been released back into this air from the electrochemical cells 104, depending on the voltage applied across the cells, as described above. If CO₂ has been absorbed, a second airflow direction valve 202 may direct the air back into the building 400. If, on the other hand, the CO₂ has been released from the electrochemical filter 104, either because the cells were saturated or because they were partly saturated and other factors made it opportune to elect to release CO₂ in order to be at better capacity later, the second airflow direction valve 202 could be in either position. If the building 400 is currently being occupied by people in both rooms the second airflow direction valve 202 may be adjusted to direct air out of the building through an exhaust air connection 203 and into the outdoor air 205, or alternatively to a CO₂ capture system for sequestration. If, on the other hand, at least one room in the building is not occupied, and not scheduled to be occupied from some time, CO₂ may be transported back into the building 400 where it will gradually exfiltrate out of the building as part of the infiltration/exfiltration process 401 that is continuously ongoing. If one room is occupied and one room is empty, a third airflow direction valve 404 can be used to direct the CO₂ rich air to the room that is empty. The air, whether it has only been subject to particle filtering, or also been subject to CO₂ capture or release, will be released back into the building through air vents 405.

The system 201 in this embodiment includes local sensors 105 and remote sensors 204. The sensors in this example include temperature sensors T, occupancy sensors O, CO₂ concentration sensors C, and particle content sensors P. The sensors are in communication with a control system 106, in this case a computer, which in turn is configured to control the various components including damper 403, fan 103, electrochemical cells 104, and airflow direction valves 107, 202, 404. Sensors 105, 204, control system 106 and actuators for dampers and valves may be communicating using a wireless network, for example as provided by wireless access point 406. The general principles by which the control system 106 controls the system 201 is described above and will not be repeated here. It should, however, be noted that the system in this embodiment is able to pull air from one room and push it back out in the other room. This means that if, for example, that air from a room with high CO₂ concentration may be moved to a room with lower CO₂ concentration after CO₂ removal. Another possibility is that if one room is occupied and the electrochemical cells 104 are saturated, CO₂ may be released from the cells and pumped into the empty room before resuming absorption of CO₂ from the air in the occupied room.

The system 201 may be further supplemented with an additional set of electrochemical cells 104. In embodiments with more than one electrochemical cell 104 operating independently of each other, it is possible to, for example, run one cell until it is saturated and then release CO₂ from the saturated cell and into an empty room or the outside air 205 while another cell starts operating to remove CO₂ from air in an occupied room and circulate that air back into the room. It will be realized that this may also require multiple air filters 102, and fans 103, or a different setup of ducts and airflow valves, but the number of fans and the number of independent cells do not have to be the same, depending on the degree of freedom to treat different rooms in different modes at the same time.

The principles illustrated in FIG. 4 may be generalized to apply to buildings with any number of rooms. Details disclosed elsewhere in this description are equally applicable to this example even if they are not illustrated in the drawing.

1-14. (canceled)

15. A system for removal of CO₂ from indoor air, the system comprising:
a fan arranged to draw air from the surroundings and force the air through the system and back into the surroundings;
at least one electrochemical cell provided in the airflow path of the system, wherein the at least one electrochemical cell is configured to absorb CO₂ from the air when a voltage V_{A} is applied across the electrochemical cell and to release previously absorbed CO₂ when a voltage V_{B} is applied across the electrochemical cell;
a control system configured to adjust at least one of the speed of the fan and the voltage across the at least one electrochemical cell; and
at least one of:
at least one sensor selected from the group consisting of: an air quality sensor and a human occupancy sensor, and
a timer configured to determine whether the current time is inside a period of time with high demands on air quality or inside a period of time with low demands on air quality;
and wherein
the control system is configured to receive information from the at least one of a sensor and a timer, determine if the received information is indicative of a need to increase CO₂ absorption from the indoor air, decrease CO₂ absorption from the indoor air, or release absorbed CO₂ from the at least one electrochemical cell back into the indoor air; and based on the determination, perform at least one of:
increase the speed of the fan, reduce the speed of the fan, and change the voltage across the at least one electrochemical cell; and
wherein the control system is further configured to release absorbed CO₂ from the at least one electrochemical cell and back into the indoor air in accordance with at least one of the following conditions:
the CO₂ concentration is below a predefined threshold as detected by an air quality sensor,
no humans are present in the surroundings as detected by a human occupancy sensor; and
the current time is inside a period of time with low demands on air quality.

16. A system according to claim 15, further comprising an air filter provided in the airflow path of the system upstream from the at least one electrochemical cell and configured to remove particles from the air streaming through the air filter.

17. A system according to claim 16, wherein the air filter is a particulate air filter in accordance with one of the standards Efficient Particulate Air requirements (EPA), High-Efficiency Particulate Air filter (HEPA), and Ultra Low Particulate Air requirements (ULPA).

18. A system according claim 16, wherein the at least one sensor includes an air quality sensor configured to measure the content of particulate matter in the air; and
wherein the control system is configured to receive a value representative of the measured content of particulate matter in the air from the air quality sensor, and if the received value is above a predefined threshold, to increase the speed of the fan.

19. A system according to claim 15, wherein the at least one sensor includes a CO₂ sensor configured to measure the concentration of CO₂ in the air; and
wherein the control system is configured to receive a value representative of the measured concentration of CO₂ in the air from the air quality sensor, and if the received value is above a predefined threshold, to perform at least one of: increasing the speed of the fan, and changing the voltage across the electrochemical cells to a level which will initiate or increase CO₂ absorption.

20. A system according to claim 15, wherein the at least one sensor includes a human occupancy sensor configured to detect the presence of humans; and
wherein the control system is configured to receive a value indicative of whether humans are present from the human occupancy sensor and to apply the voltage V_{A} across the at least one electrochemical cell if the received value indicates that humans are present, and to apply the voltage V_{B} across the at least one electrochemical cell if the value indicates that humans are not present.

21. A system according to claim 15, further comprising a first airflow direction valve provided in the airflow path between the fan and the at least one electrochemical cell; and
wherein the control system is configured to control the first airflow direction valve to adjust the relative proportion of the airflow from the fan that flows through the at least one electrochemical cell.

22. A system according to claim 15, further comprising:
a second airflow direction valve provided in the airflow path downstream from the at least one electrochemical cell and with at least one output configured to lead air back into the surrounding indoor environment and one output configured to direct air to other parts of the building in order to avoid high local concentrations of CO₂ in the indoor environment; and
wherein the control system is configured to adjust the second airflow direction valve to lead air through the output configured to lead air back into the indoor environment when the voltage V_{A} is applied across the electrochemical cell, and to adjust the second airflow direction valve to lead air through the output configured to lead air to other parts of the building when the voltage V_{B} is applied across the electrochemical cell.

23. A method of removing CO₂ from indoor air using a system with a fan, at least one electrochemical cell configured to absorb CO₂ from the air when a voltage V_{A} is applied across the electrochemical cell and to release previously absorbed CO₂ when a voltage V_{B} is applied across the electrochemical cell, a control system, and at least one of a sensor selected from the group consisting of an air quality sensor and a human occupancy sensor, and a timer configured to determine whether the current time is inside a period of time with high demands on air quality or inside a period of time with low demands on air quality; the method comprising:
using the fan to draw air from the surroundings and force the air through the at least one electrochemical cell and back into the surroundings;
providing information from the at least one of a sensor and a timer to the control system;
using the control system to determine if the received information is indicative of a need to increase CO₂ absorption from the indoor air, reduce CO₂ absorption from the indoor air, or release already absorbed CO₂ from the at least one electrochemical cell back into the indoor air; and
based on the determination (302, 305), perform at least one of increasing the speed of the fan, reducing the speed of the fan, and change the voltage across the at least one electrochemical cell; and
wherein a determination that the received information is indicative of a need to release already absorbed CO₂ from the at least one electrochemical cell and back into the indoor air is based on at least one of the following conditions:
the CO₂ concentration is below a predefined threshold as detected by an air quality sensor,
no humans are present in the surroundings as detected by a human occupancy sensor; and
the current time is inside a period of time with low demands on air quality.

24. A method according to claim 23, where the system includes an air filter provided in the airflow path of the system upstream from the at least one electrochemical cell and at least one air quality sensor configured to measure the content of particulate matter in the air, the method further comprising:
using the air quality sensor to measure the content of particulate matter in the air, and if the measured content is above a predefined threshold, using the control system to increase the speed of the fan.

25. A method according to claim 23, wherein the system includes at least one CO₂ sensor configured to measure the concentration of CO₂ in the air, the method further comprising:
using the at least one CO₂ sensor to measure the concentration of CO₂ in the air, and if the measured concentration is above a predefined threshold, using the control system to perform at least one of: increasing the speed of the fan, and changing the voltage across the electrochemical cells to a level which will initiate or increase CO₂ absorption.

26. A method according to claim 23, wherein the system includes at least one human occupancy sensor configured to detect the presence of humans, the method further comprising:
using the human occupancy sensor to determine whether humans are present, and using the control system to apply the voltage V_{A} causing CO₂ absorption across the at least one electrochemical cell if the received value indicates that humans are present, and to apply a voltage V_{B} across the at least one electrochemical cell if the value indicates that humans are not present.

27. A method according to claim 23, wherein the system includes at least one CO₂ sensor configured to measure the concentration of CO₂ in the air, and a first airflow direction valve provided in the airflow path between the fan and the at least one electrochemical cell, the method further comprising:
using the at least one CO₂ sensor to measure the concentration of CO₂ in the air, and if the measured concentration is above a predefined threshold, using the first airflow direction valve provided in the airflow path between the fan and the at least one electrochemical cell to adjust the relative proportion of airflow from the fan that flows through the at least one electrochemical cell.

28. A method according to claim 23, wherein the system includes a second airflow direction valve provided in the airflow path downstream from the at least one electrochemical cell and with at least one output configured to lead air back into the surrounding indoor environment and one output configured to direct air to other parts of the building in order to avoid high local concentrations of CO₂ in the indoor environment, the method further comprising:
adjusting the second airflow direction valve to lead air through the output configured to lead air back into the indoor environment when the voltage V_{A} is applied across the electrochemical cell, and to adjust the second airflow direction valve to lead air to other parts of the building when the voltage V_{B} is applied across the electrochemical cell.
